(19) United States
(12) Patent Application Publication
(10) Pub. No.: US 2009/0096736 A1
(43) Pub. Date: Apr. 16, 2009

(54) DRIVING APPARATUS AND DISPLAY DEVICE INCLUDING THE SAME

(76) Inventors: Hyoung-Sik Nam, Incheon-si (KR); Kwan-Young Oh, Anyang-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/192,718

(22) Filed: Aug. 15, 2008

(30) Foreign Application Priority Data
Oct. 16, 2007 (KR) 10-2007-0104141

(51) Int. Cl. G09G 3/36

(52) U.S. Cl. 345/94

(57) ABSTRACT

The present invention relates to a driving circuit for a liquid crystal display and a driving method thereof. A signal controller of the driving circuit generates a data signal according to an input image signal input to the display device, generates a clock signal according to the input control signal, and generates a differential pair image signal by modulating the clock signal to the data signal. Here, a data signal period of the differential pair image signal and a clock signal period are converted with a different level and are output. A data driver of the driving device receives the differential pair image signal, divides the data signal and the clock signal from the differential pair image signal, and generates a data voltage by sampling a data signal by using the clock signal.

### CROSS-REFERENCE TO RELATED APPLICATION

This application claims priority to and the benefit of Korean Patent Application No. 10-2007-0104141 filed in the Korean Intellectual Property Office on Oct. 16, 2007, the entire contents of which are incorporated herein by reference.

### BACKGROUND OF THE INVENTION

(a) Field of the Invention

The present invention relates to a driving apparatus for a display device and a display device including the same.

(b) Description of the Related Art

Recently, flat panel displays such as an organic light emitting device (OLED), a plasma display panel (PDP), and a liquid crystal display (LCD) have been developed as substitutes for the cathode ray tube (CRT) which is heavy and large.

A PDP is a device that displays characters or images using plasma generated by a gas-discharge, and an OLED is a device that displays characters or images using electroluminescence of a specific organic material or high molecules. An LCD displays desired images by applying an electric field to a liquid crystal (LC) layer interposed between two panels and regulating the strength of the electric field to adjust the transmittance of light passing through the LC layer.

Among such flat panel displays, as examples, the LCD and the OLED each include a display panel provided with pixels including switching elements and display signal lines, a gate driver for providing gate signals to gate lines among the display signal lines to turn on/off the switching elements of the pixels, a gray voltage generator for generating a plurality of gray voltages, a data driver for selecting a voltage corresponding to an image data as a data voltage from the gray voltages and applying the data voltage to a data line among the display signal lines, and a signal controller for controlling the above elements.

Each driver is supplied with necessary predetermined voltages and converts them into various voltages to drive the display device. For example, the gate driver receives a gate-on voltage and a gate-off voltage and alternatively applies them to the gate line as a gate signal. A gray voltage generator receives a uniform reference voltage and divides it through a plurality of resistors to provide divided voltages to a data driver.

It is necessary for the driving apparatus of the display device to use a data transmitting technique with high speed in the driving apparatus to realize a display having a large size and high resolution. In particularly, to transmit the data signals between the signal controller and the data driver with high speed, an intra-panel-interface of a point-to-point method is used. Generally, the data driver includes a plurality of source drivers, and each source driver is connected to the signal controller through an independent signal line in the intra-panel-interface of the point-to-point method. Accordingly, disconformities of the impedances are decreased compared with the conventionally multi-drop method in which a plurality of source drivers are connected through one signal line such that electromagnetic interference may be reduced. Also, if an embedded clock with which clock signals are inserted between the data signals by applying a multi-level signaling technique is used, an additional signal line to transmit the clock signals is not necessary. Also, the data signals and the clock signals are separately transmitted such that problems due to skew generated between the data signals and the clock signals may be prevented.

However, while the size of the display panel according to the display device of the large size is increased, the length of the signal lines of the interface between the data driver and the signal controller to display the data signals of the display panel is increased. As a result of the increased length of the signal lines, the signal slew-rate input to the signal lines is decreased because of the increased resistance and the parasitic capacitance due to the long signal lines. The signal slew-rate means the rate of change of the signal levels as a function of time. Therefore, because the signal slew-rate is decreased by the increased length of the signal lines, the signals transmitted from the signal controller to the data driver may be distorted.

The above information disclosed in this Background section is only for enhancement of understanding of the background of the invention and therefore it may contain information that does not form the prior art that is already known in this country to a person of ordinary skill in the art.

### SUMMARY OF THE INVENTION

To solve this problem, a technical object of the present invention is to provide a driving apparatus of a liquid crystal display and a driving method to transmit data signals with high speed without distortion.

A driving device for a display device displaying images according to an input image signal and an input control signal according to an exemplary embodiment of the present invention includes a signal controller generating a data signal according to the input image signal, generating a clock signal according to the input control signal, generating a differential pair image signal by modulating the clock signal to the data signal, and respectively converting the data signal period and the clock signal period of the differential pair image signal into a different level, wherein the signal controller converts the differential pair image signal of the period of converting the level of the data signal among the data signal periods into the same level as the differential pair image signal of the clock signal period during a predetermined initial emphasis period. The signal controller includes an inter-panel transmitter receiving the data signal and the clock signal, generating a modulation signal by inserting the clock signal to the data signal with a predetermined interval, converting the modulation signal into the differential pair image signal having the different level respectively corresponding to the data signal period and the clock signal period, and converting the differential pair image signal of the data signal period during the initial emphasis period. The inter-panel transmitter includes: a serial unit receiving the data signal and aligning it in series; a multiplex unit inserting the clock signal to the arranged data signal in series to generate the modulation signal; an image signal generator receiving the modulation signal, converting the modulation signal into the differential pair image signal having the different level corresponding to the data signal period and the clock signal period, and converting the differential pair image signal of the data signal period during the initial emphasis period; and a transmission controller receiving the information for the data signal, the clock signal, and the predetermined initial emphasis period, controlling the position for inserting the clock signal to the data signal according to the predetermined interval, and controlling an amplification degree according to the data signal period of the level of the differential pair image signal, the clock signal period, and the initial emphasis period. A data driver receiving the differential pair image signal, dividing the data signal and the clock signal from the differential pair image signal, and sampling the data signal by using the clock signal to generate a data voltage may be included, and the initial emphasis period may be determined according to a slew-rate for the time of the differential pair image signal transmitted between the signal controller and the data driver. The differential pair image signal of the data signal period may be less than the differential pair image signal of the clock signal period. The differential pair image signal may further include a data control signal for controlling the operation of the data driver, the signal controller may add a data active signal period to a data signal period of the differential pair image signal, and the differential pair image signal of the data signal period according to the differential pair image signal of the data active signal period is the data signal or the data control signal. The data driver may recover the clock signal with a frequency corresponding to a frequency of the data signal, sample the data signal by using the recovered clock signal to generate a digital data signal, and generate a data voltage corresponding to the digital data signal.

A driving method for a display device displaying images according to the input image signal and input control signal according to an exemplary embodiment of the present invention includes modulating by inserting the clock signal generated according to the input control signal to a data signal corresponding to the input image signal with the predetermined interval, converting the modulated signal into a differential pair image signal by discriminating the different level according to the period corresponding to the data signal and the period corresponding to the clock signal, and converting the differential pair image signal according the change of the data signal level into the same level as the differential pair image signal of the clock signal during a predetermined initial emphasis period. The driving method may further include generating a data voltage corresponding to the input image signal by receiving the differential pair image signal, and the generating of the data voltage may include recovering the clock signal with the frequency corresponding to the frequency of the data signal, generating a digital data signal by sampling the data signal by using the recovered clock signal, and selecting a data voltage corresponding to the digital data signal among a plurality of gray voltages. The modulating may be executed by further including a data control signal to the data signal and clock signal, and the data control signal is a signal for controlling the generating the data voltage. The converting into the differential pair image signal with a multiplex level may further include converting by further including a data active signal to represent whether the differential pair image signal of the data signal period corresponds to one of the data signal and the data control signal. The generating of the data voltage may further include dividing the data control signal from the differential pair image signal. The initial emphasis period may be determined according to the slew-rate of the differential pair image signal transmitted and received in the display device for the time.

### BRIEF DESCRIPTION OF THE DRAWINGS

The accompanying drawings described below along with the following written description illustrate exemplary embodiments of the present invention.

FIG. 1 is a block diagram of a liquid crystal display according to an exemplary embodiment of the present invention.

FIG. 2 is an equivalent circuit diagram of one pixel in the liquid crystal display according to an exemplary embodiment of the present invention.

FIG. 3 shows image signals generated by a signal controller according to an exemplary embodiment of the present invention.

FIG. 4 shows image signals including a data control signal according to an exemplary embodiment of the present invention.

FIG. 5 is a block diagram showing connections between a signal controller and a plurality of source drivers according to an exemplary embodiment of the present invention.

FIG. 6 is a block diagram of a signal controller according to an exemplary embodiment of the present invention.

FIG. 7 is a block diagram of an inter-panel transmitter 650 shown in FIG. 6.

FIG. 8 is a block diagram of a source driver according to an exemplary embodiment of the present invention.

FIG. 9 shows image signals input to source drivers according to an exemplary embodiment of the present invention.

### DETAILED DESCRIPTION OF THE EMBODIMENTS

The present invention is described more fully hereinafter with reference to the accompanying drawings, in which exemplary embodiments of the invention are shown.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

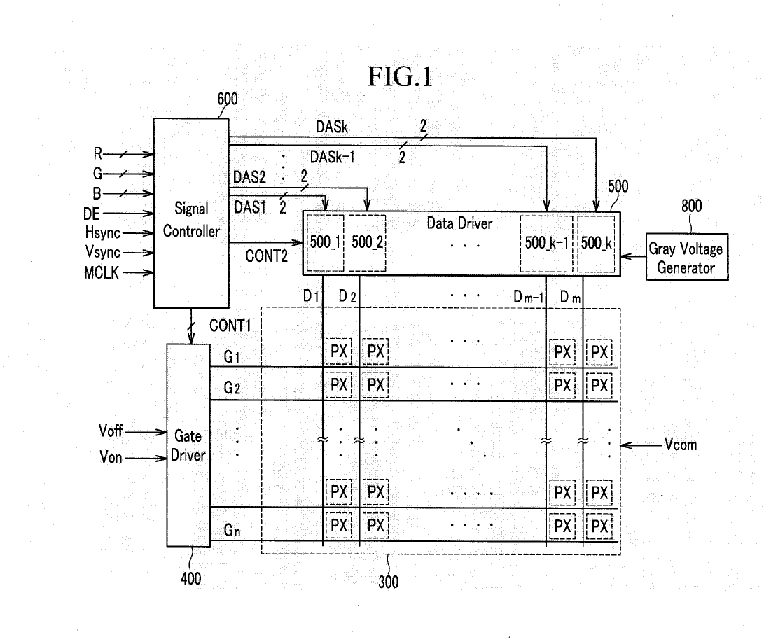

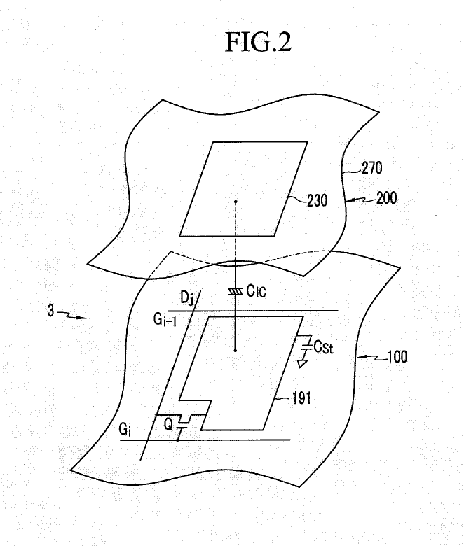

Firstly, a liquid crystal display according to an exemplary embodiment of the present invention is described below in detail with reference to FIG. 1 and FIG. 2.

FIG. 1 is a block diagram of a liquid crystal display according to an exemplary embodiment of the present invention, and FIG. 2 is an equivalent circuit diagram of one pixel in the liquid crystal display according to an exemplary embodiment of the present invention.

Referring to FIG. 1, a liquid crystal display according to an exemplary embodiment of the present invention includes a liquid crystal panel assembly 300, a gate driver 400, a data driver 500, a gray voltage generator 800, and a signal controller 600.

Referring to FIG. 1, in an equivalent circuit, the liquid crystal panel assembly 300 includes a plurality of signal lines G1-Gn and D1-Dm, and a plurality of pixels PX that are connected to the plurality of signal lines G1-Gn and D1-Dm and are arranged in an approximate matrix shape. Meanwhile, referring to a structure shown in FIG. 2, the liquid crystal panel assembly 300 includes lower and upper display panels 100 and 200 that face each other, and a liquid crystal layer 3 that is interposed between the lower and upper display panels 100 and 200.

The signal lines G1 to Gn and D1 to Dm include a plurality of gate lines G1 to Gn for delivering gate signals (also referred to as scan signals) and a plurality of data lines D1 to Dm for delivering data signals. The gate lines G1 to Gn extend in an approximate row direction and are almost parallel to each other, and the data lines D1 to Dm extend in a column direction and almost parallel to each other.

Each pixel, for example a pixel PXij connected to an i-th (i=1, 2, . . . , n) gate line Gi and a j-th (j=1, 2, . . . , m) data line Dj, includes a switching device Q that is connected to a signal line (Gi, Dj), a liquid crystal capacitor Clc that is connected to the switching device Q, and a storage capacitor Cst. The storage capacitor Cst may be omitted if necessary.

The switching element Q is a three-terminal element included in the lower display panel 100, such as a thin film transistor. In the switching device Q, a control terminal is connected to a gate line Gi, an input terminal is connected to a data line Dj, and an output terminal is connected to the liquid crystal capacitor Clc and the storage capacitor Cst

The liquid crystal capacitor Clc has a pixel electrode 191 of the lower display panel 100 and a common electrode 270 of the upper display panel as two terminals, and the liquid crystal layer 3 between the two electrodes 191 and 270 functions as a dielectric. The pixel electrode 191 is connected to the switching device Q. The common electrode 270 is formed on the whole surface of the upper display panel 200, and a common voltage Vcom is applied to the common electrode 270. The common electrode 270 may be included in the lower display panel 100, differently from a case illustrated in FIG. 2, and in that case, at least one of the two electrodes 191 and 270 may be formed in a shape of a line or a bar.

The storage capacitor Cst that serves as an auxiliary to the liquid crystal capacitor Clc is formed as a separate signal line (not shown) provided on the lower panel 100 and the pixel electrode 191 overlapping it with an insulator interposed therebetween, and a predetermined voltage such as the common voltage Vcom or the like is applied to the separate signal line. Also, the storage capacitor Cst can be formed as the pixel electrode 191 overlaps with the immediately previous gate line G(i−1) by the medium of the insulator.

In order to realize a color display, each pixel PX specifically displays one of the primary colors (spatial division), or the pixels PX alternately display the primary colors over time (temporal division), which causes the primary colors to be spatially or temporally synthesized, thereby displaying a desired color. An example of the primary colors is three primary colors including red, green, and blue colors. FIG. 2 is an example of the spatial division. As shown in the figure, each of the pixels PX includes a color filter 230 representing one of the primary colors and that is disposed in a region of the upper display panel 200 corresponding to a pixel electrode 191. Unlike as in FIG. 2, the color filter 230 may be formed above or below the pixel electrode 191 of the lower display panel 100.

At least one polarizer (not shown) for polarizing light is attached to an outer surface of the liquid crystal panel assembly 300.

Referring to FIG. 2 again, the gray voltage generator 800 generates all gray voltages or a limited number of gray voltages (hereinafter referred to as “reference gray voltages”) related to the transmittance of the pixels PX. The (reference) gray voltages may include gray voltages that have a positive value and gray voltages that have a negative value with respect to the common voltage Vcom.

The gate driver 400 is connected to the gate lines G1-Gn of the display panel assembly 300 and synthesizes a gate-on voltage Von and a gate-off voltage Voff to generate gate signals, which are applied to the gate lines G1-Gn.

The data driver 500 is connected to the data lines D1-Dm of the display panel assembly 300, and selects gray voltages supplied from the gray voltage generator 800 and then applies the selected gray voltages to the data lines D1-Dm as data voltages. However, in the case when the gray voltage generator 800 supplies only a limited number of reference gray voltages rather than supplying all gray voltages, the data driver 500 divides the reference gray voltages to generate desired data voltages. The data driver 500 according to an exemplary embodiment of the present invention includes a plurality of source drivers 500_1-k, and each source driver 500_1-k directly receives image signals DAS1-K from the signal controller 600 according to the point-to-point method. The source drivers 500_1-k are connected to the corresponding data lines, and apply data voltages to the corresponding the data lines. The source drivers 500_1-k apply the data voltages to the data lines according to the same gate control signal CONT2 that is transmitted to the source drivers 500_1-k from the signal controller 600, and accordingly the data voltages may be transmitted to the pixels PX connected to the same row with the same timing.

The signal controller 600 controls the gate driver 400 and the data driver 500.

Each of the driving circuits 400, 500, 600, and 800 may be directly mounted as at least one integrated circuit (IC) chip on the panel assembly 300 or on a flexible printed circuit film (not shown) in a tape carrier package (TCP) type, which are attached to the LC panel assembly 300, or may be mounted on a separated printed circuit board (not shown). Alternatively, the driving circuits 400, 500, 600, and 800 may be integrated with the panel assembly 300 along with the signal lines G1-Gn and D1-Dm and the TFT switching elements Q. Further, the driving circuits 400, 500, 600, and 800 may be integrated as a single chip. In this case, at least one of them or at least one circuit device constituting them may be located outside the single chip.

Below the operation of the above-described LCD is explained in detail.

The signal controller 600 is supplied with input image signals R, G, and B and input control signals for controlling the display thereof from an external graphics controller (not shown). The input image signals R, G, and B contain luminance information for each pixel (PX). The luminance has a predetermined number of grays, such as 1024 (=2¹⁰), 256 (=2⁸), or 64 (=2⁶). The input image signals R, G, and B and the input control signals according to an exemplary embodiment of the present invention may be signals following low voltage differential signaling (after referred to as “LVDS”). The input control signals include, for example, a vertical synchronization signal Vsync, a horizontal synchronization signal Hsync, a main clock signal MCLK, and a data enable signal DE.

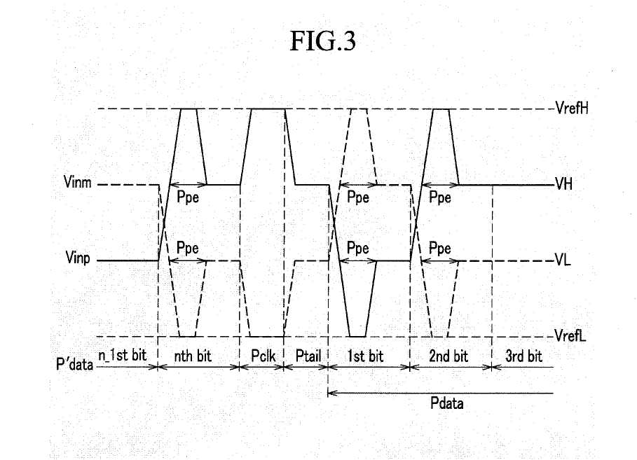

The signal controller 600 processes the input image signals R, G, and B in such a way to be suitable for the operating conditions of the liquid crystal panel assembly 300 based on the input image signals R, G, and B of the LVDS mode and the input control signal. The signal controller 600 generates a plurality of image signals DAS1-k, a gate control signal CONT1, a data control signal CONT2, and so on, and it sends the gate control signal CONT1 to the gate driver 400 and the data control signal CONT2 and a processed image signals DAS1-k to the data driver 500. Each of the image signals DAS1-k according to an exemplary embodiment of the present invention is a differential pair signal are generated according to a multi-level signaling mode in which clock signals CLK having different magnitudes from the data signals DATA are inserted between the data signals DATA that are the image data. The clock signal CLK is a signal having a predetermined frequency for sampling the data signals DATA input to the data driver 500 as a receiving terminal, and the clock signal CLK may have the same frequency as the data signals DATA, or a lesser frequency than the data signals DATA. Also, the data control signal CONT2 is transmitted to the data driver 500 through the different signal line in FIG. 1, but the present invention is not limited by this and a plurality of image signals DAS1-k may be transmitted to the data driver 500 by the same signal line along with the data control signal CONT2. The image signals according to an exemplary embodiment of the present invention are explained in detail with reference to FIG. 3.

The gate control signal CONT1 includes a scan start signal STV for indicating scan start, and at least one clock signal for controlling an output period of the gate-on voltage Von. The gate control signal CONT1 may further include an output enable signal OE for limiting a time duration of the gate-on voltage Von.

The data control signal CONT2 includes a horizontal synchronization start signal STH for indicating initiation of data transmission of the image signals DAS1-k to the data driver 500 for a row (group) of pixels PX, a load signal LOAD for requesting to apply analog data voltages to the data lines D1 to Dm, and a data clock signal HCLK. The data control signal CONT2 may further include a reverse signal RVS for inverting voltage polarity of the data signal with respect to the common voltage Vcom (hereinafter, “voltage polarity of the data signal with respect to the common voltage” is abbreviated to “polarity of the data signal”).

The data driver 500 includes a plurality of source drivers 500_1-k, and each source driver 500_1-k receives a corresponding image signal among the image signals DAS1-k. The source drivers 500_1-k separate the clock signals CLK from the received image signals DAS1-k to restore the clock signal CLK to the predetermined frequency or generate a plurality of multi-phase clock signals by using the clock signal CLK. The source drivers 500_1-k sample the data signals DATA by using the restored clock signals CLK or the generated clock signals CLK to generate the digital image signals DAT. Here, the predetermined frequency to which the clock signal CLK is restored and the frequency of the generated clock signals CLK may be the same frequency as the data signal DATA or a frequency corresponding to half of the data signal DATA. When the restored clock signal CLK has the same frequency as the data signal DATA, the data signal DATA is sampled in synchronization with the rising edge timing of the restored clock signal, and when the clock signal CLK has the half frequency of the data signal DATA, the data signal DATA is sampled in synchronization with the rising edge timing and falling edge timing of the clock signal CLK. The data driver 500 selects a grayscale voltage corresponding to each digital image signal DAT to generate the digital image signals DAT as analog data signals. Thereafter the data driver 500 applies the generated analog data signals to corresponding data lines D1 to Dm.

The gate driver 400 applies a gate-on voltage Von to the gate lines G1 to Gn according to the gate control signal CONT1 transmitted from the signal controller 600 to turn on switching devices Q connected to the gate lines G1 to Gn, and then the data signals applied to the data lines D₁ to Dₘ are applied to corresponding pixels PX through the turned-on switching devices Q.

A difference between a voltage of the data signal applied to the pixels PX and the common voltage Vcom appears as a charged voltage of the liquid crystal capacitor Clc, that is, a pixel voltage. Alignment of the liquid crystal molecules varies according to the magnitude of the pixel voltage to change the polarization of light passing through the liquid crystal layer 3. The transmittance of light is changed by a polarizer attached to the liquid crystal panel assembly 300 according to the change in the polarization such that the pixels PX display the luminance corresponding to the grays of the digital image signals DAT.

In units of one horizontal period, which may be written as “1H” and is the same as one period of the horizontal synchronization signal Hsync and the data enable signal DE, the aforementioned operations are repeatedly performed to sequentially apply the gate-on voltages Von to all the gate lines G₁ to Gₙ, so that the data signals are applied to all the pixels PX. As a result, one frame of the image is displayed.

When one frame ends, the next frame starts, and a state of the reverse signal RVS applied to the data driver 500 is controlled so that the polarity of the data signal applied to each of the pixels is opposite to the polarity in the previous frame (frame inversion). At this time, even in one frame, according to the characteristics of the reverse signals RVS, the polarity of the data signal flowing through one data line may be inverted (row inversion and dot inversion). In addition, the polarities of the data signals applied to one pixel row may be different from each other (column inversion and dot inversion).

FIG. 3 is a view showing one image signal DASq among the image signals DAS1-k generated in a signal controller 600 according to an exemplary embodiment of the present invention. The image signal DASq is applied to a corresponding source driver 500_{—}q among a plurality of source drivers 500_1-k of the data driver 500. The signal controller 600 according to an exemplary embodiment of the present invention generates the image signal DASq by inserting the clock signal CLK in the data signals DATA representing a plurality of bits corresponding to one pixel. Here, the image signal DASq according to an exemplary embodiment of the present invention includes a data signal period Pdata representing the data signals DATA made of a plurality of n bits as a differential pair signals, a clock signal period Pclk representing the clock signal CLK as a differential pair signal, and a clock tail period Ptail representing a clock tail signal adding the same bits as the n-th bits of the signals DATA as a differential pair signal. In FIG. 3, the data signal period Pdata is a data signal of a different pixel connected the different data line from the data line applied with the data signal DATA among a plurality of data lines connected to the source driver 500_{—}q. One pixel is a unit including three sub-pixels representing R, G, and B colors, and if the gray of each color is 8 bits, the image signal DASq represents the data of total 26 bits including 24 bits representing the gray bits of three colors R, G, and B, 1 bit represents the clock signal CLK, and 1 bit represents the clock tail signal CLKt. That is, the image signal DASq is a differential pair signal corresponding to the total of 26 bits. This is an exemplary embodiment of the present invention and the present invention is not limited by it. Differently from FIG. 3, the clock signal CLK may be inserted between each bit of the data signals DATA one by one. When the level transition of the data signals DATA is generated, the signal controller 600 modulates the levels of the positive signal Vinp and the negative signal Vinm of the initial predetermined period (hereinafter, initial emphasis period) Ppe. The level transition is the magnitude transition of the data signal generated when the previous bits of the data signal are different from the data of the present bits. In detail, the image signal DASq as the differential pair signal includes the positive signal Vinp and the negative signal Vinm. The image signal DASq represents the digital data by using the positive signal Vinp and the negative signal Vinm forming the differential pair signal. If the difference between the positive signal Vinp and the negative signal Vinm is positive, the image signal DASq represents the digital data “1”, and if the difference between the positive signal Vinp and the negative signal Vinm is negative, the image signal DASq presents the digital data “0”. The positive signal Vinp of the differential pair signal corresponding to the 1st bit of the data signals DATA is less than the negative signal Vinm of the differential pair signal. Accordingly, the 1st bit corresponds to the digital data “0”. The 2nd bit corresponds to the digital data “1”, because the positive signal Vinp is greater than the negative signal Vinm. Here, when each of the positive signal Vinp and the negative signal Vinm are changed from the 1st bit to the signal corresponding to the 2nd bit, the change width is large. However, the signal slew-rate of the image signal DASq is low in the period transmitted from the signal controller 600 to the source driver 500_{—}q through the signal line. The signal distortion is generated due to the low signal slew-rate in the period in which the image signal DASq is transmitted to the source driver 500_{—}q through the signal line. Because the positive signal Vinp is a lower level VL in the 1st bit and the positive signal Vinp is a high level VH in the 2nd bit, the increasing slope of the signal for the time is small in the low signal slew-rate such that the transition period is long. Conversely, because the negative signal Vinm is a high level VH in the 1st bit and the negative signal Vinm is a low level VL in the 2nd bit, the transition period is also long in this case. Therefore, the signal distortion is generated, and the source driver 500_{—}q may output the data voltage of the different gray from the original input image signals R, G, and B to the data line due to the signal distortion. Accordingly, the present invention improves the low signal slew-rate to prevent the signal distortion. If each transition width of the differential pair signal of the data signal DATA is large, during the initial emphasis period Ppe, the differential pair signal of the data signal DATA is converted into the same level as the differential pair signal of the clock signal CLK. Each level of the positive signal Vinp and the negative signal Vinm of the initial emphasis period Ppe among the period corresponding to each bit is respectively modulated into the same level as the maximum value VrefH or the minimum value VrefL of the clock signal CLK. Accordingly, the signal distortion may be prevented in the period in which the image signal DASq is transmitted to the source driver 500_{—}q. Also, because the same level as the differential pair signal of the clock signal CLK is used, an additional amplification circuit is not necessary. Also, the change of the data signal DATA is not generated in the 2nd bit and the 3rd bit, because the level transition of the positive signal Vinp and the negative signal Vinm is not generated, the differential signal of the image signal DASq does not include the initial emphasis period Ppe. The initial emphasis period Ppe according to an exemplary embodiment of the present invention is determined by considering the slew-rate of the signal transmitted through the signal line between the signal controller 600 and the data driver 500. The lower the slew-rate is, the greater increased the initial emphasis period Ppe is. To separate the data signal and the clock signal by receiving the image signal DASq from the data driver 500, the difference between the levels of two signals is required. If the maximum value of the data signal is the same as the maximum value of the clock signal by extremely increasing the initial emphasis period Ppe, the data driver 500 may generate the error when separating the data signal DATA and the clock signal CLK. Accordingly, the initial emphasis period Ppe is determined as a period that is sufficient to compensate the low slew-rate of the signal, but the data signal received from the data driver 500 is not the maximum value that is the same as the clock signal.

The image signal DASq according to an exemplary embodiment of the present invention further includes the differential pair signal representing one bit after the clock trail signal such that the image signal DASq may be transmitted along with the data control signal CONT2 to the source driver

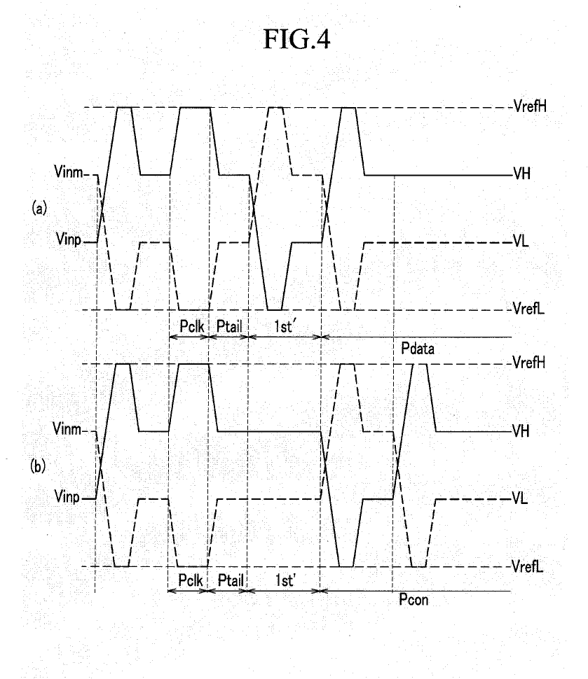

FIG. 4 shows an image signal DASq including a data control signal CONT2 according to an exemplary embodiment of the present invention

In detail, as shown in FIG. 4, portion (a), a data active signal DA corresponding to one bit is added after the clock tail signal to distinguish between the data signal DATA and the data control signal CONT2. The differential pair signal 1st disposed after the clock tail signal represents the data active signal DA. If the positive signal Vinp of the differential pair signal 1st is smaller than the negative signal Vinm of the differential pair signal 1st, the differential pair signal of the data signal period Pdata is the period Pcon represents the data control signal CONT2, not the data signal. In contrast, as shown in FIG. 4, portion (b), if the positive signal Vinp of the differential pair signal 1st is larger than the negative signal Vinm, the differential pair signal of the data signal period Pdata represents the data signal DATA.

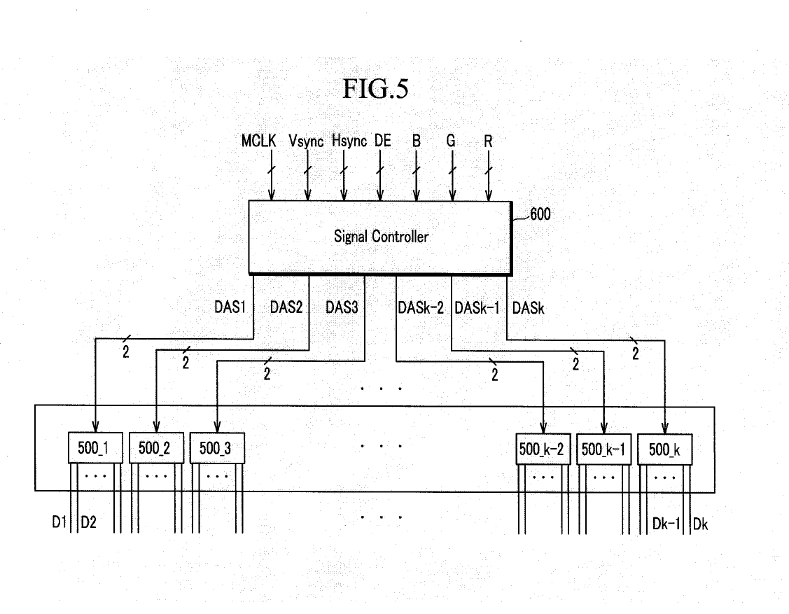

FIG. 5 is a block diagram showing a connection structure between signal controller 600 and a plurality of source drivers 500_1 to 500_{—}k according to an exemplary embodiment of the present invention

Each source driver 500_1-k respectively receives the image signals DAS1 to DASk from the signal controller 600, and coverts them into a plurality of data voltages to transmit the data voltages to a plurality of data lines D1-Dm.

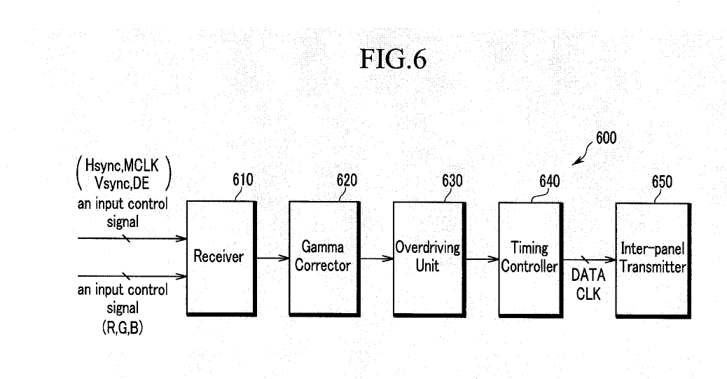

FIG. 6 is a view showing a signal controller 600 according to an exemplary embodiment of the present invention.

As shown in FIG. 6, the signal controller 600 includes a receiver 610, a gamma corrector 620, an overdriving unit 630, a timing controller 640, and an inter-panel transmitter 650.

The receiver 610 receives input image signals R, G, and B and input control signals Hsync, Vsync, MCLK, and DE of an LVDS mode from an external graphics controller to generate image data according to the input image signals and a synchronization control signal for displaying the images. The synchronization control signal includes a clock signal CLK.

The gamma corrector 620 executes a gamma correction to adjust the image data to the liquid crystal display. The gamma corrected image data is transmitted to the overdriving unit 630.

The overdriving unit 630 compares the frame data directly before the gamma corrected image data with the present frame data. If a gray change between the frame data is larger than a predetermined value, the present frame data is amplified to compensate a response speed. A liquid crystal layer included in the display device of the liquid crystal display has a slow response speed, and when the gray change between the previous frame and the present frame is large, it is difficult to display the correct gray of the present frame data. The overdriving unit 630 is an element to improve this.

The timing controller 640 generates the gate control signal CONT1, the data control signal CONT2, and the clock signal CLK by using the synchronization control signal, and controls the alignment of the image data according to the synchronization control signal to transmit the data signal DATA and the clock signal CLK to the inter-panel transmitter 650. In detail, the timing controller 640 generates the data signal DATA and the clock signal CLK transmitted to the source drivers 500_1-k to transmit to the inter-panel transmitter 650 in series.

The inter-panel transmitter 650 divides the input data signals DATA and the input clock signal CLK, and generates a plurality of image signals DAS1-k described in FIGS. 3 and 4 to transmit to the source drivers 500_1-k.

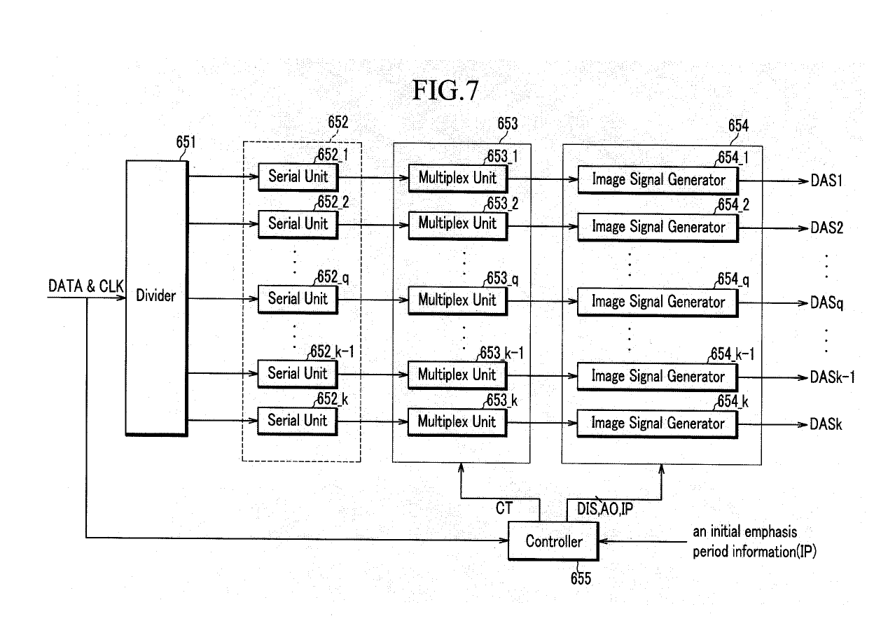

The inter-panel transmitter 650 is described in detail with reference to FIG. 7.

FIG. 7 shows inter-panel transmitter 650 according to an exemplary embodiment of the present invention.

As shown in FIG. 7, the inter-panel transmitter 650 includes a divider 651, a serial mean 652, a multiplex mean 653, an image signal generator 654, and a transmission controller 655. The serial mean 652 includes a plurality of serial units 652_1-k, the multiplex mean 653 includes a plurality of multiplex units 653_1-k, and the image signal generator 654 includes a plurality of image signal generators 654_1-k.

The divider 651 divides the data signals DATA, which are received in series, with a predetermined unit to respectively transmit them to a plurality of serial units 652_1-k. The predetermined unit according to an exemplary embodiment of the present invention is a unit of the data signals DATA that are transmitted to one row of pixels corresponding to the number of data lines respectively connected to one source driver 500_1-k.

Each of the serial units 652_1-k converts the received data signals DATA, and transmits them to the multiplex units 653_1-k.

Each of the multiplex units 653_1-k modulates the converted data signals DATA and the clock signal CLK according to the control of the transmission controller 655 to respectively transmit them to the image signal generators 654_1-k. For example, the multiplex units 653_{—}q inserts the clock signal CLK of 1 bit and the clock trail signal CLKt of 1 bit between the data signal DATA of one pixel and another data signal DATA of the neighboring pixel.

This generated modulation signal is transmitted to the image signal generator 654_{—}q. Also, the multiplex unit 653_{—}q may generate a modulation signal by inserting a data active signal DA of one bit after the period of the clock trial signal CLKt. The other multiplex unit of the multiplex mean 653 is operated the same way.

Each image signal generator 654_1-k converts the modulation signal that is input from the corresponding multiplex unit 653_1-k into the image signal DAS1-k to respectively transmit to the source driver 500_1-k. As described above in FIGS. 3 and 4, the image signal generator 654_{—}q generates the image signal DASq that is made of the differential pair. Here, the controller 655 receives the information IP, the data signal DATA, and the clock signal CLK for the initial emphasis period Ppe, and controls each image signal generator 654_1-k to respectively generate the image signals DAS1-k of the differential pair.

The transmission controller 655 controls the multiplex unit 653_1-k to modulate the data signal and the clock signal according to the predetermined information, and controls the image data generators 654_1-k to amplify the data signal DATA and the clock signal CLK into the differential pair signal having the different level and output it. In detail, the transmission controller 655 transmits the modulation order signal CT inserting the clock signal CLK with the predetermined period unit in the data signals DATA according to the predetermined information to the multiplex units 653_1-k. Each multiplex unit 653_1-k inserts the clock signal CLK between the data signals DATA according to the modulation order signal CT, and respectively transmits them to the image signal generators 654_1-k. The predetermined information may be data previous stored to a data base (not shown) of a liquid crystal display, and may be included in an additional data base to store the predetermined information by the controller 655.

The transmission controller 655 controls the image signal generators 654_1-k for the clock signal and the data signal to be a differential pair signal having the different level according to the predetermined information. Also, if it is detected to generate the level conversion of the data signals DATA, the transmission controller 655 controls the image signal generator 654_1-k for the level of the differential pair signal of the data signals DATA to be the same level as the clock signal CLK during the initial emphasis period. In detail, the transmission controller 655 transmits the discrimination signal DIS to the image signal generator 654_1-k to inform whether the modulation signal input to the image signal generator 654_1-k is the data signal DATA or the clock signal CLK. The image signal generator 654_1-k generates image signals by respectively converting the differential pair signal corresponding to the data signal DATA and the clock signal CLK according to the discrimination signal DIS into the different level. Also, if it is detected to generate the level change of the data signal DATA, the transmission controller 655 transmits the information IP and the amplify order signal AO for the initial emphasis period Ppe to the image signal generator 654_1-k. The image signal generator 654_1-k amplifies the positive signal Vinp among the differential pair signal of the data signal DATA according to the received information IP and order signal AO into the level of the maximum value VrefH of the clock signal CLK and the negative signal Vinm into the level of the minimum value VrefL of the clock signal CLK and outputs them. In this way, the image signal generator 654_1-k receives the modulation signal that the clock signal CLK is inserted in the data signal DATA, amplifies the data signal DATA and the clock signal CLK into the differential pair signal of the different level according to the order of the transmission controller 655, and generates the image signal DAS1-q for the differential pair signal of the data signal DATA to have the same level as the differential pair level signal of the clock signal CLK upon the level conversion of the data signal DATA. Also, when the differential pair image signal of the data signal also includes a data control signal, the transmission controller 655 determines the level of the data active signal DA and transmits it to the image signal generator 654_{—}q. Therefore, the image signal generator 654_{—}q converts a differential pair image signal DASq of the period corresponding to the data active signal DA and outputs it.

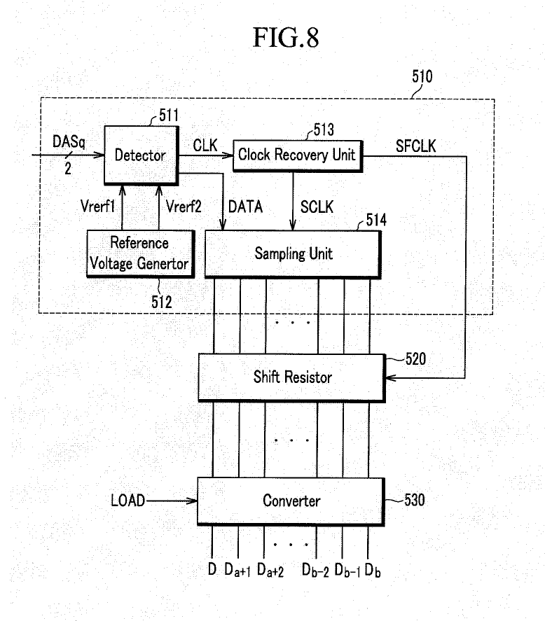

Next, the source drivers will be described with reference to FIG. 8.

FIG. 8 is a block diagram of one source driver 500_{—}q among a plurality of source drivers 500_1-k according to an exemplary embodiment of the present invention. The other source drivers also have the same structure as the source driver 500_{—}q.

The source driver 500_{—}q includes a receiver 510, a latch unit 520, and a converter 530. The source driver 500_{—}q is connected to a plurality of data lines Da-Db.

The receiver 510 includes a detector 511, a reference voltage generator 512, a clock recovery unit 513, and a sampling unit 514.

The reference voltage generator 512 generates a maximum reference voltage Vref1 and a minimum reference voltage Vref2 for the detector 511 to discriminate the data signal DATA and the clock signal CLK from the differential pair image signal DASq. The maximum reference voltage Vref1 is less than the maximum value VrefH and is more than the high level VH of the differential pair signal, and the minimum reference voltage Vref2 is more than the minimum value VrefL and the lower level VL of the differential pair signal.

The detector 511 receives the differential pair image signal DASq and detects the voltage of the image signal DASq to divide the clock signal CLK and the data signal DATA by using the maximum reference voltage Vref1 and the minimum reference voltage Vref2. When the differential pair image signal having the initial emphasis period Ppe is transmitted to the source driver through the signal line, the amplified signal level is reduced during the initial emphasis period Ppe.

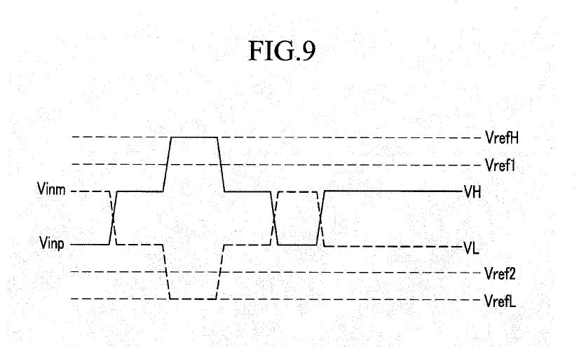

FIG. 9 shows image signals input to the source driver 500_{—}q according to an exemplary embodiment of the present invention. For convenience of the explanation, the signal shown in FIG. 3 is input to the source driver 500_{—}q. As shown in FIG. 9, the signal of which the difference between the positive signal Vinp and the negative signal Vinm of the differential pair image signal DASq received by the detector 511 is less than the differences between the maximum reference voltage Vref1 and the minimum reference voltage Vref2 is determined to be the data signal DATA, and the signal of which the difference between the positive signal Vinp and the negative signal Vinm of the differential pair image signal DASq received by the detector 511 is more than the differences between the maximum reference voltage Vref1 and the minimum reference voltage Vref2 is determined to be the clock signal CLK. The detector 511 respectively divides the data signal DATA and the clock signal CLK and transmits them to the sampling unit 514 and the clock recovery unit 513. When the image signal DASq includes the data control signal CONT2, the detector 511 compares the differential pair of the data active signal DA. If the positive signal is less than the negative signal, the data control signal CONT2 is detected in the differential pair image signal DASq.

The clock recovery unit 513 recovers the received clock signal CLK with the same frequency as the frequency of the data signal DATA to generate the sampling clock signal SCLK for sampling the data signal DATA. The sampling unit 514 samples the data signal DATA in synchronization with the rising edge point of the sampling clock signal SCLK, and may generate the digital data. Alternatively, the sampling unit 514 generates a sampling clock signal SCLK having a frequency corresponding to half of the frequency of the data signal DATA, and samples the data signal DATA at the rising and falling points of the sampling clock signal SCLK to generate the digital data. On the other hand, the clock recovery unit 513 may generate a plurality of sampling clock signals SCLK having a multi-phase shifted by the predetermined period, and the sampling unit 514 may generate the digital data by sampling the data signal DATA in synchronization with the rising edge point of the clock signal SCLK of the multi-phase. Here, the predetermined period corresponds to the period that the data signal DATA represents the data of 1 bit. Also, the clock recovery unit 513 generates the signal for the data treatment in the source driver 500_{—}q. In detail, the clock signal CLK is converted according to the data control signal CONT2 that is directly transmitted from the signal controller 600 or is transmitted along with the image signal, and a clock signal SFCLK having a predetermined frequency is generated. The generated clock signal SFCLK is used for the shift register 520 to store by shifting the digital data. The sampling unit 514 transmits the digital data to the shift register.

The shift register 520 shifts and stores the transmitted digital data according to the clock signal SFCLK. The shift register 520 may store the digital data with changing the address of the register at the rising edge point of the clock signal SFCLK. Also, if the digital data that will be input to the pixels PX of the one row connected to the data lines Da-Db connected to the source driver 500_{—}q are all stored, the digital data are simultaneously transmitted to the converter 530 in parallel.

The converter 530 selects the gray voltage according to the received digital data and converts the digital data into the data voltage, and stores then simultaneously outputs the plurality of data voltages to the plurality of data lines Da-Db according to the load signal LOAD.

These operations are respectively generated in the plurality of source drivers 500_1-k, because each source driver 500_1-k receives the same data driving control signal for controlling the synchronization and the points at which the data voltages are transmitted to the plurality of pixels of one row from each source driver 500_1-k are with same.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

Accordingly, in the driving device of the display device and the driving method thereof according to an exemplary embodiment of the present invention, the data signals between the signal controller and the source driver may be transmitted without distortion.

What is claimed is:

1. A driving circuit for a display device for displaying images responsive to an input image signal and an input control signal, the driving circuit comprising:
a signal controller generating a data signal according to the input image signal, generating a clock signal according to the input control signal, generating a differential pair image signal by modulating the clock signal to the data signal, and respectively converting the data signal period and the clock signal period of the differential pair image signal into different levels, wherein the signal controller is operative to convert the differential pair image signal of the period of converting the level of the data signal among the data signal periods into the same level as the differential pair image signal of the clock signal period during a predetermined initial emphasis period.

2. The driving circuit of claim 1, wherein the signal controller further includes an inter-panel transmitter receiving the data signal and the clock signal, generating a modulation signal by inserting the clock signal to the data signal with a predetermined interval, converting the modulation signal into the differential pair image signal having the different level respectively corresponding to the data signal period and the clock signal period, and converting the differential pair image signal of the data signal period during the initial emphasis period.

3. The driving circuit of claim 2, wherein the inter-panel transmitter comprises:
a serial unit receiving the data signal and aligning it in series;
a multiplex unit inserting the clock signal to the arranged data signal in series to generate the modulation signal;
an image signal generator receiving the modulation signal, converting the modulation signal into the differential pair image signal having the different level respectively corresponding to the data signal period and the clock signal period, and converting the differential pair image signal of the data signal period during the initial emphasis period; and
a transmission controller receiving the information for the data signal, the clock signal, and the predetermined initial emphasis period, controlling the position of inserting the clock signal to the data signal according to the predetermined interval, and controlling an amplification degree according to the data signal period of the level of the differential pair image signal, the clock signal period, and the initial emphasis period.

4. The driving circuit of claim 1, further comprising a data driver receiving the differential pair image signal, dividing the data signal and the clock signal from the differential pair image signal, and sampling the data signal by using the clock signal to generate a data voltage.

5. The driving circuit of claim 3, wherein the initial emphasis period is determined according to a slew-rate for the time of the differential pair image signal transmitted between the signal controller and the data driver.

6. The driving circuit of claim 4, wherein the differential pair image signal further includes a data control signal for controlling the operation of the data driver.

7. The driving circuit of claim 6, wherein the signal controller adds a data active signal period to a data signal period of the differential pair image signal, and the differential pair image signal of the data signal period according to the differential pair image signal of the data active signal period is the data signal or the data control signal.

8. The driving circuit of claim 4, wherein the data driver
recovers the clock signal with a frequency corresponding to a frequency of the data signal, samples the data signal by using the recovered clock signal to generate a digital data signal, and generates a data voltage corresponding to the digital data signal.

9. The driving circuit of claim 4, wherein the differential pair image signal of the data signal period is less than the differential pair image signal of the clock signal period.

10. A driving method for a display device displaying images responsive to an input image signal and an input control signal, the method comprising:
modulating a data signal corresponding to the input image signal by inserting a clock signal generated according to the input control signal to the data signal with a predetermined interval;
converting the modulated signal into a differential pair image signal by discriminating a different level according to a period corresponding to the data signal and a period corresponding to the clock signal; and
converting the differential pair image signal according to the change of the data signal level into the same level as the differential pair image signal of the clock signal during a predetermined initial emphasis period.

11. The driving method of claim 10, further comprising:
generating a data voltage corresponding to the input image signal by receiving the differential pair image signal, wherein the generating of the data voltage includes recovering the clock signal with a frequency corresponding to the frequency of the data signal;
generating a digital data signal by sampling the data signal by using the recovered clock signal; and
selecting a data voltage corresponding to the digital data signal among a plurality of gray voltages.

12. The driving method of claim 11, wherein the modulating is executed by further including a data control signal to the data signal and clock signal, and the data control signal is a signal for controlling the generating of the data voltage.

13. The driving method of claim 12, wherein the converting into the differential pair image signal with the multiplex level further includes converting by further including a data active signal to represent whether the differential pair image signal of the data signal period corresponds to one of the data signal or the data control signal.

14. The driving method of claim 13, wherein the generating of the data voltage further includes dividing the data control signal from the differential pair image signal.

15. The driving method of claim 10, wherein the initial emphasis period is determined according to the slew-rate of the differential pair image signal transmitted and received per the time in the display device.
